(19) United States
(12) Patent Application Publication
(10) Pub. No.: US 2016/0230374 A1
(43) Pub. Date: Aug. 11, 2016

(54) Rinse Down Sink and Disposal System

(71) Applicant: Just Manufacturing, Franklin Park, IL (US)

(72) Inventors: Paul Just, Franklin Park, IL (US); Matthew Just, Franklin Park, IL (US); Matt Gjertson, Chicago, IL (US); Richard Swanson, Arlington Heights, IL (US); Nathan Andre, Schaumburg, IL (US); Zach Kyrouac, Bourbonnais, IL (US); Junfu Hu, Urbana, IL (US)

(73) Assignee: Just Manufacturing, Franklin Park, IL (US)

(21) Appl. No.: 14/618,579

(22) Filed: Feb. 10, 2015

(51) Int. Cl. E03C 1/266; E03C 1/18; B02C 25/00

(52) U.S. Cl. CPC E03C 1/2665; B02C 25/00; E03C 1/18

(57) ABSTRACT

A system for disposing debris from a receptacle, such as a sink, where a fluid source and disposal are operatively coupled for ease of use. The system allows, for example, a user to press a single button or activate a switch to simultaneously activate the disposal and water flow for a predetermined period of time. The system can also include rinse down piping to better flush the debris into the drain of the receptacle and toward the disposal.

### TECHNICAL FIELD OF THE INVENTION

The present application relates to a combination receptacle and disposal system. Particularly, the present application relates to a receptacle having a fluid source operably coupled to a disposal system.

### BACKGROUND OF THE INVENTION

Current residential or commercial sinks commonly include disposals connected to the drain of the sink to break up unwanted debris and allow for easier rinsing of the debris. For example, when washing dishes, food debris routinely find its way into the sink drain and clog the sink. A disposal is commonly used to unclog the sink by breaking up the excess food from the dishes.

It is preferable that water be running while the disposal is in use to better wash the debris down the sink and to act as a coolant for the disposal. In conventional systems, users must turn on the water, and in a separate action, activate the disposal to begin the disposal process. This two-step process is cumbersome and many users simply run the disposal without water, resulting in poor distribution of the debris or damage to the disposal. Moreover, users are required to manually push debris down the disposal, which is dangerous.

### SUMMARY OF THE INVENTION

The present application discloses a system for disposing debris from a sink or other receptacle where the disposal and fluid source are operatively coupled together for easier use. In one embodiment, the fluid source and disposal are operatively coupled together such that a user can take a single action, for example pressing a button, that will simultaneously activate the disposal and water flow for a predetermined period of time. In other embodiments, separate actions can be implemented to allow for simultaneous use of the disposal and fluid source, although the operative connection between the disposal and fluid source allows for such simultaneous use without the conventional two-step burden familiar to users. Rinse down piping can be used to better flush the debris into the drain of the receptacle and toward the disposal for more efficient distribution of the debris.

In particular, the present application discloses a system including a receptacle having a drain, a disposal operatively coupled to the receptacle and adapted to break down debris, a fluid source adapted to distribute a fluid to the receptacle, whereby the fluid exits the receptacle through the drain and thereafter enters the disposal, a valve operatively coupled to the fluid source and adapted to allow selective distribution of the fluid to the receptacle from the fluid source, a power source operatively coupled to the disposal and adapted to supply power to the disposal, and a controller operatively coupled to the power source, valve, and disposal, and adapted to receive a signal to simultaneously permit the supply of power from the power source to the valve and to the disposal such that the signal causes simultaneous supply of the fluid from the fluid source and operation of the disposal.

Also disclosed is a system including a receptacle having a drain, a disposal operatively coupled to the receptacle and adapted to break down debris, a fluid source adapted to distribute a fluid to the receptacle, whereby the fluid exits the receptacle through the drain and thereafter enters the disposal, a valve operatively coupled to the fluid source and adapted to allow selective distribution of the fluid to the receptacle from the fluid source, a power source operatively coupled to the disposal and adapted to supply power to the disposal, a controller operatively coupled to the power source, valve, and disposal, and adapted to selectively permit the supply of power from the power source to the valve and to the disposal, and a switch adapted to cause the controller to selectively permit the supply of power from the power source to the valve and to the disposal such that the controller causes the valve to supply power and causes the disposal to operate when the switch is in a first position, and causes the valve to prevent the flow of fluid from the fluid source and causes the disposal to not operate when the switch is in a second position or when a predetermined amount of time passes.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a side sectional view of a system according to an embodiment of the present application.

FIG. 2 is a top plan view of the system with the countertop removed according to an embodiment of the present application.

FIG. 3 is a flow chart of a system assembly process according to an embodiment of the present application.

FIG. 4 is a front perspective partial view of piping according to an embodiment of the present application.

FIG. 5 is a bottom view of piping according to an embodiment of the present application.

FIG. 6 is a partial exploded view of a piping assembly according to an embodiment of the present application.

FIG. 7 is a top perspective view of a piping assembly according to an embodiment of the present application.

FIG. 8 is a side sectional view of piping according to an embodiment of the present application.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated.

The present application discloses a system for disposing debris from a receptacle where a disposal and fluid source are operatively coupled for greater ease of use and safety. The system can also include rinse down piping to better flush the debris into the drain of the receptacle and toward the disposal. For example, the rinse down piping can be disposed in the receptacle to cause a swirling effect, thus maximizing the ability to flush debris into the drain.

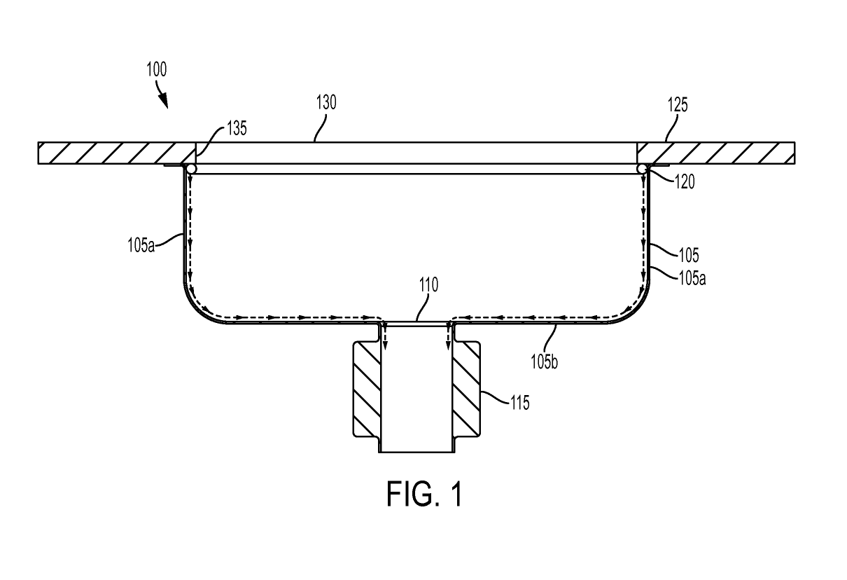

As shown in FIG. 1, the system 100 can include a receptacle 105, such as a sink, for receiving debris and water during, for example, a dishwashing process. The receptacle 105 can direct water and debris to a drain 110, and ultimately, to a disposal 115 where the debris can be broken down into smaller particles that can be more efficiently flushed away in a conventional drainage system. The system 100 can also include piping 120 to distribute water or another fluid into the receptacle 105, and a countertop 125 upon which the receptacle 105 can be mounted. The countertop 125 includes inside edges that form an internal opening 130 with a ledge 135 that, in some embodiments, conceals the piping 120 from view when viewing the system 100 from a top angle.

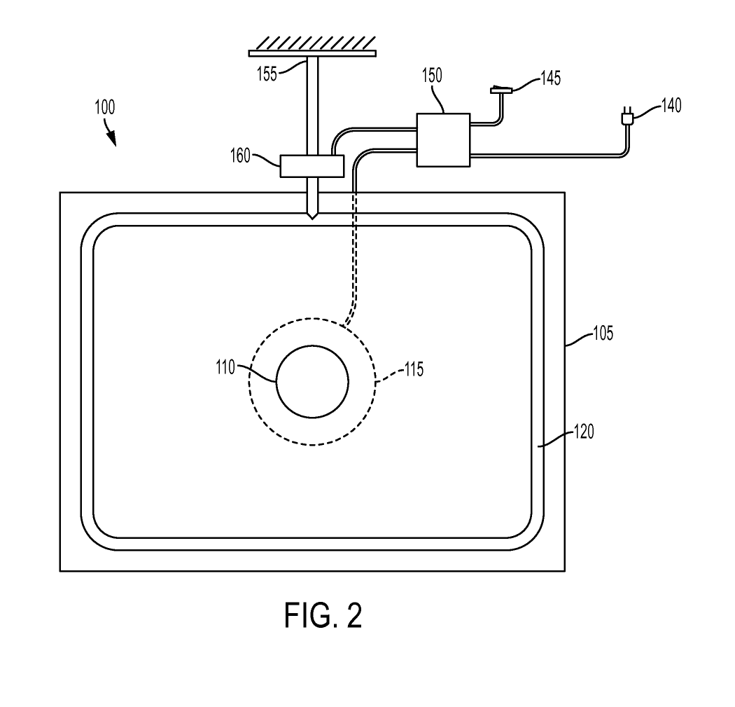

FIG. 2 depicts an embodiment of the system 100 from a top view. As shown, the system 100 can include a power source 140 to provide power to the system 100 and allow for simultaneous water distribution and disposal activation. A switch 145 can act as the interface between the user and the system 100 and cause the system 100 to function. A controller 150 can also be provided to distribute power from the power source 140 and cause the system 100 to function for a predetermined amount of time, e.g., 30 seconds. The controller 150 can be connected to the power source 140 to selectively distribute power, and to a fluid source 155 to selectively distribute fluid, such as water, based on the command provided by the user at the switch 145. The system 100 can also include a valve 160, such as, for example, a solenoid valve, operatively coupled to the fluid source 155 for selective distribution of water to the system 100.

As discussed above, the system 100 includes both a disposal 115 and a fluid source 155 operatively coupled to a switch 145 so a user can simultaneously activate the disposal 115 and the fluid source 155 by, for example, pressing the switch 145. The controller 150 can then cause the valve 160 to open to distribute water to the receptacle 105 through the piping 120 and flush debris within the receptacle 105 toward and into the drain 110 and to the disposal 115. During at least some of the period in which the water is being distributed, the controller 150 can also cause the disposal 115 to operate to break down the debris for easier disposal through external plumbing, or otherwise. The present invention thus ensures that fluid is distributed while the disposal 115 is in operation. Moreover, in an embodiment, the piping 120 can be configured in such a way to cause the water to agitate or otherwise swirl within the receptacle 105, thus maximizing the ability of the water to remove debris from the receptacle into the drain 110.

The receptacle 105 can be any container or enclosure without departing from the spirit and scope of the present application. The receptacle 105 is preferably a stainless steel sink, although other materials can be used, such as metal, ceramic, plastic, or otherwise. The receptacle 105 preferably has one or more side portions 105a and one or more bottom portions 105b, where water can be distributed down the side portions 105a to flush debris toward the bottom portions 105b and toward the drain 110 into the disposal 115. It will be appreciated that the size and shape of the receptacle 105 is not limited, and can include, for example, rectangular, square, triangular, or circular configurations. The disposal 115 can be any conventional or custom-made garbage disposal.

The piping 120 can be any form of plumbing that causes water to flow into the receptacle 105 and down the drain 110. As shown, and in an embodiment, the piping 120 is wash down piping that runs along a top perimeter of the receptacle 105, close to bottom side of the countertop 125. The wash down piping can include downwardly facing nozzles or apertures that distribute water or other fluids down the side portions 105a of the receptacle 105 to better flush debris from the receptacle 105. Such piping 120 can include a single nozzle or apertures, multiple nozzles or apertures, two or more rows of nozzles or apertures that alternate distributing water or that distribute water together, nozzles arranged to distribute in an angled pattern, or any other form of nozzles or apertures. The piping 120 can also include a tube with nozzles or apertures that rotates to distribute the water in a rotational pattern to maximize the wash down effect. However, the piping 120 can be any form of plumbing, for example a standard faucet or copper or PVC hose.

The countertop 125 can be any conventional or custom-made countertop without departing from the spirit and scope of the present application. For example, the countertop 125 can be laminate, granite, wood, quartz, marble, stainless steel, glass, concrete, soapstone, travertine, tile, or any other countertop material. In an embodiment, the countertop 125 includes a ledge 135 that hides the piping 120 underneath. The countertop 125 can also be coupled to the piping 120, and the piping 120 can be additionally coupled to the receptacle 105. In another embodiment, the piping 120 can be coupled to only the countertop 125 and not to the receptacle 105.

The power source 140 can be any source of power, including a standard two or three prong outlet with 120V electricity, stand-alone battery, fuel cell, generator, hydraulic power source or any other source of power.

The switch 145 can be any interface that allows the user to control the system 100, including a standard wall switch, an infrared remote, a button, touch screen, touch sensor (such as on a faucet or otherwise), knob, lever, or any other object maneuverable or capable of being activated by a user to operate the system 100. In a preferred embodiment, the switch 145 is a wall switch connected to the power source 140.

The controller 150 can be any device that communicates with the valve 160 to cause the valve to open and close and control the output of water from the fluid source 155 and with the disposal 115. In an embodiment, the controller 150 includes software stored on a non-transitory computer readable recording medium and operatively coupled to a processor to control the valve 160 and disposal 115. For example, the controller 150 can transmit a signal to the valve 160, causing the valve to open, and simultaneously turn on the disposal 115 such that the fluid source 155 and disposal 115 operate simultaneously for a predetermined amount of time. More particularly, the user can activate the switch 145, causing the controller 150 to cause the valve 160 to open and turn on the disposal 115 for a period of 30 seconds, and then automatically close the valve 160 and turn off the disposal 115. In another embodiment, the switch 145 can be a timer that automatically turns the disposal 115 off and closes the valve 160. In yet another embodiment, the controller can be configured to allow the valve 160 to remain open for a set amount of time, for example 30 seconds, after the disposal 115 is shut off. This ensures that an adequate amount of water flushes the disposal 115.

The fluid source 155 can be any source of water or other fluid, for example, a stand-alone container of water or plumbing indirectly connected to a water distribution system. Similarly, the valve 160 can be any form of valve that selectively controls output of water or other fluids from the fluid source 155, such as a solenoid valve. The fluid source 155 can have one or more tubes that connect to the piping 120 to distribute water in a pattern that effectively washes debris from the receptacle 105. For example, the fluid source 155 can include multiple tubes that alternate distributing water to respective rows of nozzles 120, as discussed above, so that water can be distributed in an oscillating pattern.

In an embodiment, the disposal 115 can communicate with the controller 150 so that when, for example, the disposal 115 is jammed or otherwise plugged, the controller 150 can shut off power to the disposal 115 and shut off valve 160 to prevent further fluid distribution. This ensures that, should a clog or other error occur, the receptacle does not overflow with fluid or water.

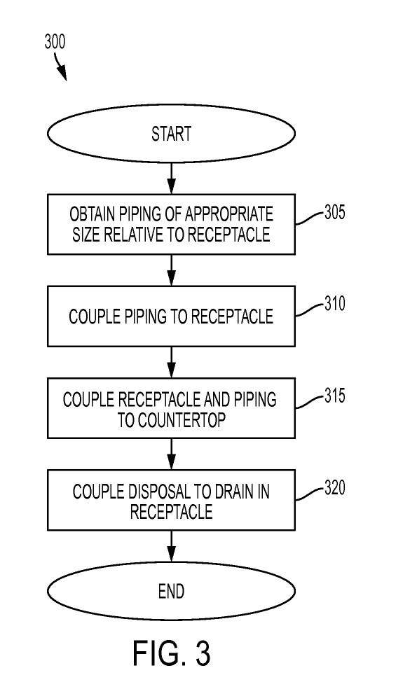

FIG. 3 is a flow chart illustrating a process for assembling and installing the system 100 according to embodiments of the present application. As shown, the process 300 begins and proceeds to step 305, where piping 120 is obtained. Appropriate piping 120 can be rinse down piping that runs along an upper circumference of the receptacle 105, as discussed above. However, any suitable piping 120 can be used.

Next, the process proceeds to step 310 where the piping 120 is coupled to the receptacle 105. For example, the drip down piping can be coupled along the upper circumference of the receptacle 105. A countertop 125 can then be coupled to the receptacle 105 and/or piping 120 in step 315. For example, the countertop 125 can be coupled to the receptacle 105 in such a manner as to conceal the piping 120 from view. Following this step, the disposal 115 can be coupled to the drain 110 of the receptacle 105 in step 320, and the process 300 can then end.

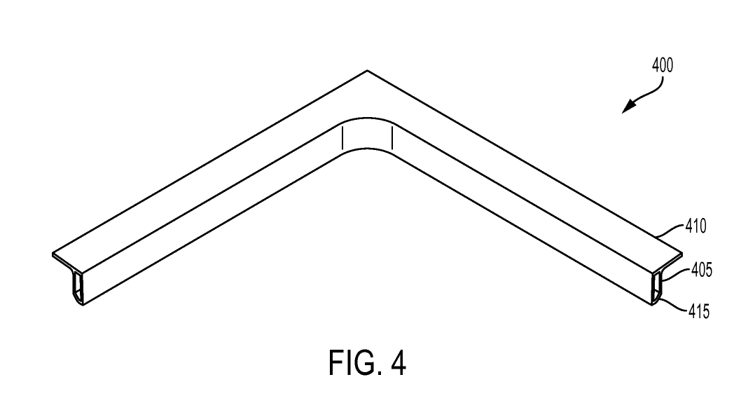

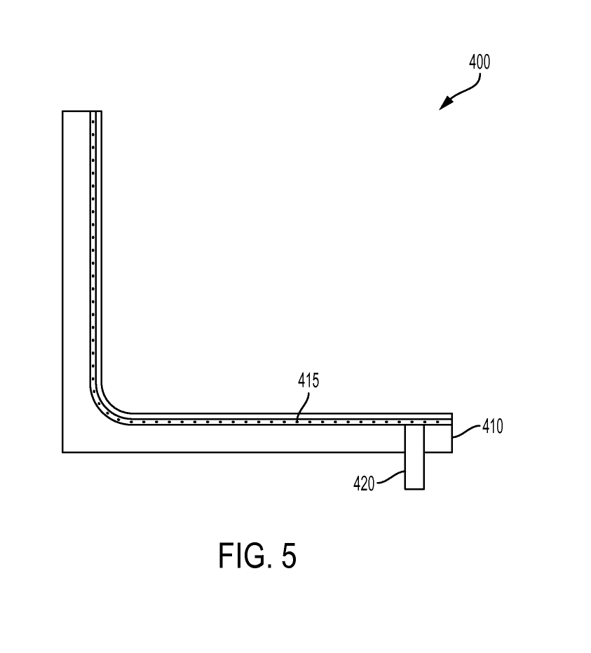

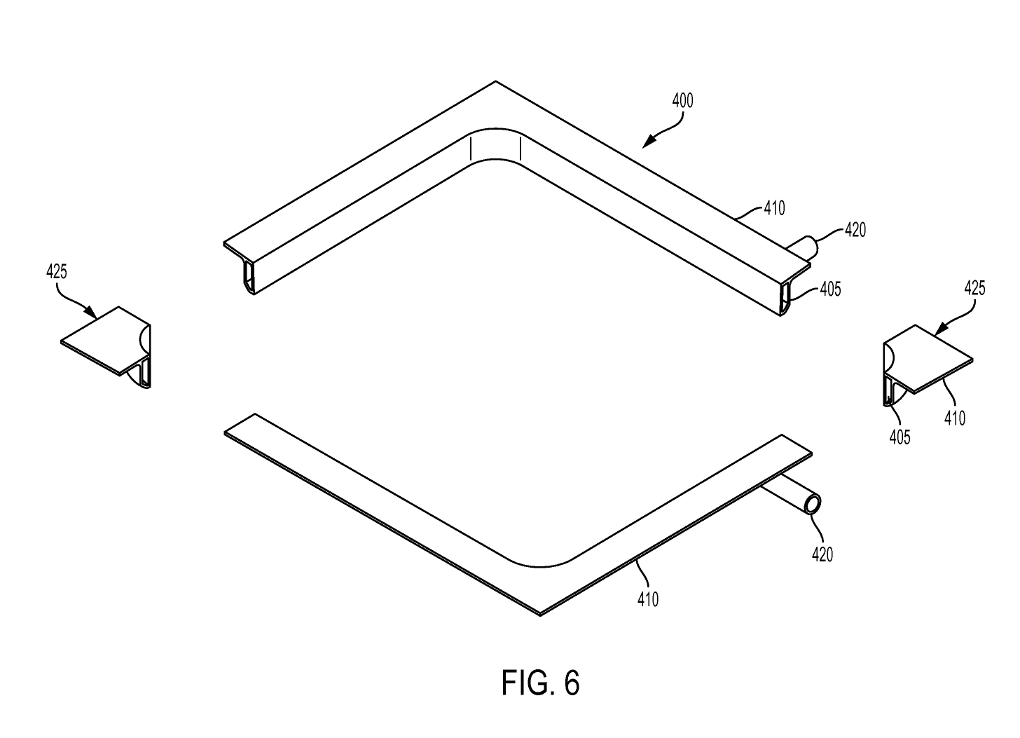

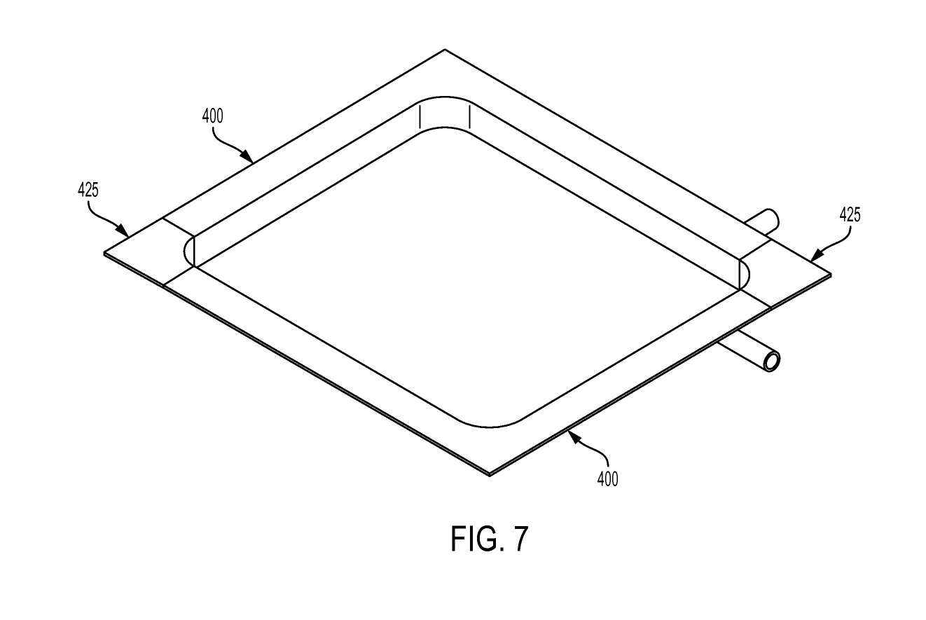

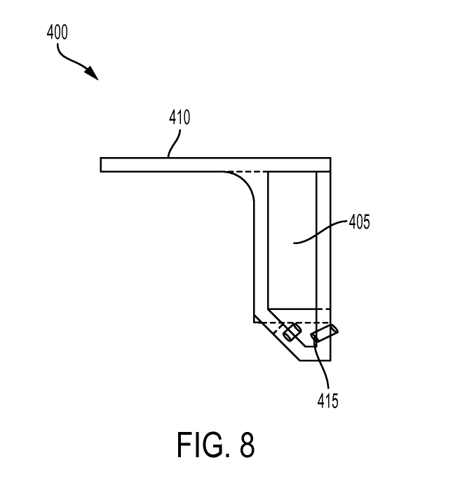

FIGS. 4-8 disclose an embodiment of the piping 120. As shown, piping 400 can include a housing 405 and a flange 410 extending from the housing 405. Nozzles or apertures 415 are defined within the housing 405 to distribute water or other fluids to the receptacle 105 and flush debris down the drain 110. As shown in, for example FIGS. 5-7, a tube 420 can deliver water or other fluids from the fluid source 155 to the housing 405. For ease of assembly, the piping 400 can include individual units of piping 400 connected together by corner pieces 425, as shown in, e.g., FIGS. 6 and 7.

The piping 400 is advantageous because it includes a flange 410 that can be inserted between the top of the receptacle 105 and the bottom side of the countertop 125 for easy installation and substantially hiding the piping 400 after installation and during use. For example, the flange 410 can be coupled between the top of the receptacle 105 and the bottom side of the countertop 125 with adhesive or with fasteners to improve the structural stability of the piping 400. The piping 400 can extend around the periphery of the receptacle 105 and distribute water as necessary to flush debris into the drain 110. In an embodiment, the piping 400 can be integral or otherwise coupled to sidewalls of the receptacle 105.

The housing 405 can be any structure that allows for the flow of water or other fluid. As shown, the housing 405 is an enclosed structure that extends around the periphery of the receptacle 105 and that houses water that is eventually distributed through the nozzles 415. However, the housing 405 need not extend entirely around the receptacle 105, and can be located anywhere relative to the receptacle 105 without departing from the spirit and scope of the present application.

The flange 410 can be any structure that extends from the housing 405. As discussed above, the flange 410 allows for easy coupling between the receptacle 105 and the countertop 125 and can be coupled to the receptacle 105 or countertop 125 by adhesive or fasteners, for example. The flange 410 need not extend completely around the periphery of the receptacle 105 and can be intermittent.

The nozzles 415 are similar to the nozzles discussed above with respect to the piping 120 and can include all variations discussed above with respect to the piping 120. As shown, the nozzles 415 can be defined within an angular portion of the housing 405 such that the nozzles 415 are aimed at the sides 105a of the receptacle 105 for better flushing of debris. However, the nozzles 415 can be disposed in any manner without departing from the spirit and scope of the present application.

The tubes 420 can be any structural device that is coupled to the fluid source 425 and capable of distributing water or other fluids to the housing 405. The tubes 420 can enter any portion of the housing 405 and can be singular or plural in nature.

As shown in FIGS. 6 and 7, in a preferred embodiment, the piping 400 includes two L-shaped pieces and two corner pieces 425 coupling together the L-shaped pieces. The corner pieces 425 can be similar in structure to the L-shaped piping 400 and can include any attribute as discussed above with respect to the piping 400. Alternatively, the corner pieces 425 can be solid in nature, or can include a housing 405 but omit any nozzles 415. In another embodiment, the piping 400 can be unitary and bent into a desired configuration.

As discussed herein, the system 100 allows for the simultaneous activation of the disposal 115 and fluid source 155. The term “simultaneous” (and variants thereof) is not intended to mean that the disposal 115 and fluid source 155 start and stop at the exact same moment, although such a system is can be implemented in an embodiment. Rather, the term “simultaneous” simply means that, at some point in time, both the disposal 115 and fluid source 155 are active based on the interoperability of the disposal 115 and fluid source 155. For example, the system 100 may send a signal to the controller 150 to allow the valve 160 to release water from the fluid source 155 upon sensing that the disposal 115 is currently operating, all without requiring an additional user action. Other forms of simultaneous operation of the disposal 115 and fluid source 155 can be implemented without departing from the spirit and scope of the present application.

The term “coupling,” (and variants thereof, including but not limited to “operatively coupled”), as used herein, can mean any direct or indirect connection between any two objects, and is not intended to necessarily mean any direct and/or permanent connection between two objects, although a direct and permanent connection can be implemented in certain embodiments. The term “coupling” is also not intended to be limited to a physical connection, and can include a direct or indirect physical, electrical, thermal, or magnetic connection, for example.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of Applicant's contribution. The actual scope of the protection sought is intended to be defined in the following claims when viewed in their proper perspective based on the prior art.

What is claimed is:

1. A system comprising:
a receptacle having a drain;
a disposal operatively coupled to the drain and adapted to break down debris;
a fluid source adapted to distribute a fluid to the receptacle, whereby the fluid exits the receptacle through the drain and thereafter enters the disposal;
a valve operatively coupled to the fluid source and adapted to allow selective distribution of the fluid into the receptacle from the fluid source;
a power source operatively coupled to the disposal and adapted to supply power to the disposal; and
a controller operatively coupled to the valve and disposal, and adapted to receive a signal to simultaneously open the valve and turn the disposal on such that the signal causes simultaneous supply of the fluid from the fluid source and operation of the disposal.

2. The system of claim 1, further comprising a switch adapted to initiate the transmission of the signal.

3. The system of claim 1, further comprising piping adapted to distribute the fluid into the receptacle.

4. The system of claim 3, wherein the piping is rinse down sink piping extending around an upper periphery of the receptacle and adapted to distribute the fluid down side portions of the receptacle.

5. The system of claim 3, further comprising a flange extending from the piping at least partially around an upper periphery of the receptacle.

6. The system of claim 1, further comprising a countertop coupled to the receptacle.

7. The system of claim 5, further comprising a countertop disposed above the receptacle, and wherein the flange is coupled to at least one of the countertop and the receptacle.

8. The system of claim 3, further comprising a countertop disposed above the receptacle, and wherein the countertop includes an opening defined by an inner edge of the countertop, and a ledge extending proximate the inner edge and adapted to conceal the piping.

9. The system of claim 1, wherein the disposal is adapted to send a signal to the controller that the disposal is operating, and the controller is adapted to open the valve upon receipt of the signal from the disposal indicating that the disposal is operating.

10. A system comprising:
a receptacle having a drain;
a disposal operatively coupled to the drain and adapted to break down debris;
a fluid source adapted to distribute a fluid to the receptacle, whereby the fluid exits the receptacle through the drain and thereafter enters the disposal;
a valve operatively coupled to the fluid source and adapted to allow selective distribution of the fluid to the receptacle from the fluid source;
a power source operatively coupled to the disposal and adapted to supply power to the disposal;
a controller operatively coupled to the valve and disposal, and adapted to selectively permit the supply of power from the power source to the valve and to the disposal; and
a switch adapted to cause the controller to selectively open and close the valve and turn the disposal on and off such that the controller causes the valve to open and the disposal to operate when the switch is in a first position, and causes the valve to close and the disposal to turn off when the switch is in a second position.

11. The system of claim 10, wherein the valve is a solenoid valve.

12. The system of claim 10, further comprising piping adapted to distribute the fluid to the receptacle.

13. The system of claim 12, wherein the piping is rinse down sink piping extending around an upper periphery of the receptacle and adapted to distribute the fluid down side portions of the receptacle.

14. The system of claim 12, further comprising a flange extending from the piping at least partially around an upper periphery of the receptacle.

15. The system of claim 10, further comprising a countertop coupled to the receptacle.

16. The system of claim 14, wherein the flange is coupled to at least one of the countertop and the receptacle.

17. The system of claim 15, wherein the countertop includes an opening defined by inner edge of the countertop, and a ledge extending proximate the inner edge and adapted to conceal the piping.

18. The system of claim 8, wherein the disposal is adapted to send a signal to the controller that the disposal is operating, and the controller is adapted to cause the valve to open upon receipt of the signal from the disposal indicating that the disposal is operating.

19. The system of claim 10, wherein the controller causes the valve to close and the disposal to turn off after a predetermined amount of time.

20. The system of claim 10, wherein the controller causes the valve to close after a predetermine amount of time that the disposal has been turned off.
